(19) United States
(12) Patent Application Publication
(10) Pub. No.: US 2013/0109806 A1
(43) Pub. Date: May 2, 2013

(54) COLOR-STABLE CURING AGENT COMPOSITIONS COMPRISING POLYISOCYANATES OF (CYCLO)ALIPHATIC DIISOCYANATES

(71) Applicants: Harald SCHAEFER, Mannheim (DE); Horst Binder, Lampertheim (DE); Thomas Genger, Lambsheim (DE); Daniel Flojhar, Ludwigshafen (DE)

(72) Inventors: Harald SCHAEFER, Mannheim (DE); Horst Binder, Lampertheim (DE); Thomas Genger, Lambsheim (DE); Daniel Flojhar, Ludwigshafen (DE)

(21) Appl. No.: 13/660,253

(22) Filed: Oct. 25, 2012

Related U.S. Application Data
(60) Provisional application No. 61/552,463, filed on Oct. 28, 2011.

(51) Int. Cl. C09K 3/00; C09D 175/04; C08K 5/521; C08K 5/5313; C08K 5/42

(52) U.S. Cl. 524/710; 524/745; 252/183.11

(57) ABSTRACT

The present invention relates to a new process for preparing polyisocyanates of (cyclo)aliphatic diisocyanates, said polyisocyanates containing isocyanurate groups and being stable with respect to color drift in solvents.

The present invention relates to new, color-drift-stable compositions of polyisocyanates of (cyclo)aliphatic diisocyanates.

U.S. Pat. No. 6,376,584 B1 describes various stabilizers for use in polyurethane compositions in which polyisocyanates are reacted with polyols in the presence of dibutyltin dilaurate.

Not disclosed are the stabilization problems that arise when polyisocyanate compositions are mixed with a catalyst and stored.

U.S. Pat. No. 7,122,588 B2 describes coating materials, including polyurethane coating materials, which are stabilized with esters of hypophosphorous acid for the purpose of longer life and to counter discoloration.

Not disclosed are the stabilization problems which arise when polyisocyanate compositions are mixed with a catalyst and stored. Moreover, the stabilization described therein is still not sufficient, and so there continues to be a need for improved stabilization.

DE 19630903 describes the stabilization of isocyanates with the aid of various phosphorus compounds and phenols.

Not described in each case is the presence of catalysts for the reaction between isocyanate groups and groups reactive therewith.

WO 2005/089085 describes polyisocyanate compositions as curing agents for 2K (two component) polyurethane coating materials that in addition to a catalyst for the reaction between isocyanate groups and groups reactive therewith comprises a stabilizer mixture selected from hindered phenols and secondary arylamines and also organophosphites, more particularly trialkyl phosphites. Explicitly disclosed in the examples is a polyisocyanate composition, the isocyanurate Tolonate HDT, with dibutyltin dilaurate as catalyst in butyl acetate/methyl amyl ketone/xylene 1:1:0.5.

A disadvantage of phosphites, however, particularly of trialkyl phosphites and more particularly of tributyl phosphite, is that they have a very unpleasantly reeking odor. In terms of toxicological classification, tributyl phosphite is injurious to health on contact with the skin, and corrosive. Triphenyl phosphite is irritant to eyes and skin, and highly toxic for aquatic organisms.

Phosphites, moreover, are sensitive to moisture. Consequently these compounds, at least before and during incorporation into polyisocyanate compositions, represent a problem from the standpoints of health, occupational hygiene, and processing. Whereas the antioxidative action of aromatic phosphites is lower than that of their aliphatic counterparts, the availability of the aliphatic phosphites is poorer.

The product mixtures described in patent specifications WO 2008/116893, WO 2008/116894, and WO 2008/116895 mandatorily comprise polyisocyanate, Lewis acid, primary antioxidant (sterically hindered phenol), and secondary antioxidant: thio compound (WO 2008/116893), phosphonite (WO 2008/116895) or phosphonate (WO 2008/116894). In addition, they may optionally comprise an acidic stabilizer, which is a Brønsted acid. Those contemplated include organic carboxylic acids, carbonyl chlorides, inorganic acids, such as phosphoric acid, phosphorous acid, and hydrochloric acid, for example, and diesters, examples being the alkyl diesters and/or aryl diesters of phosphoric acid and/or phosphorous acid, or inorganic acid chlorides such as phosphorus oxychloride or thionyl chloride, for example. Finding preferred use as acidic stabilizers are aliphatic monocarboxylic acids having 1 to 8 C atoms, such as formic acid and acetic acid, for example, and aliphatic dicarboxylic acids having 2 to 6 C atoms, such as oxalic acid and more particularly 2-ethylhexanoic acid, for example, chloropropionic acid and/or methoxyacetic acid. Alkyl and/or aryl diesters of phosphoric acid are not said to be preferred. Sulfonic acid derivatives are not stated.

These Brønsted acids specified in the patent applications are used more particularly in order to prevent viscosity rise, or even gelling, of polyisocyanates in bulk, i.e. without solvent. Thus WO 2008/068197 describes the corresponding use of methoxyacetic acid, EP 643042 likewise a corresponding use. The use for reducing color on storage in synergy with sterically hindered phenols is not described.

It is an object of the present invention to provide further storage-stable polyisocyanate compositions which already include a catalyst for the reaction between isocyanate groups and groups reactive therewith and are color-stable, and whose stabilizers, in terms of odor, toxicology and/or moisture sensitivity, allow unproblematic occupational hygiene and health, and whose stabilizing action is at least comparable with that of the prior art. The stabilizing action ought to be independent of the origin of the monomeric isocyanate.

This object has been achieved by polyisocyanate compositions comprising
(A) at least one polyisocyanate obtainable by reacting at least one monomeric isocyanate,
(B) at least one compound able to accelerate the reaction of isocyanate groups with isocyanate-reactive groups,
(C) at least one Brønsted acid having a pKa of less than 4,
(D) at least one sterically hindered phenol,
(E) at least one solvent,
(F) optionally other, typical coatings additives.

Polyisocyanate compositions of this kind feature good color stability over time on storage (“color drift”) and can be reacted with components comprising isocyanate-reactive groups in polyurethane coating materials.

The monomeric isocyanates used may be aromatic, aliphatic or cycloaliphatic, preferably aliphatic or cycloaliphatic, which is referred to for short in this text as (cyclo)aliphatic; aliphatic isocyanates are particularly preferred.

Aromatic isocyanates are those which comprise at least one aromatic ring system, in other words not only purely aromatic compounds but also araliphatic compounds.

Cycloaliphatic isocyanates are those which comprise at least one cycloaliphatic ring system.

Aliphatic isocyanates are those which comprise exclusively linear or branched chains, i.e., acyclic compounds.

The monomeric isocyanates are preferably diisocyanates, which carry precisely two isocyanate groups. They can, however, in principle also be monoisocyanates, having one isocyanate group.

In principle, higher isocyanates having on average more than 2 isocyanate groups are also contemplated. Suitability therefor is possessed for example by triisocyanates, such as triisocyanatononane, 2′-isocyanatoethyl 2,6-diisocyanatohexanoate, 2,4,6-triisocyanatotoluene, triphenylmethane triisocyanate or 2,4,4′-triisocyanatodiphenyl ether, or the mixtures of diisocyanates, triisocyanates, and higher polyisocyanates that are obtained, for example, by phosgenation of corresponding aniline/formaldehyde condensates and represent methylene-bridged polyphenyl polyisocyanates.

These monomeric isocyanates do not contain any substantial products of reaction of the isocyanate groups with themselves.

The monomeric isocyanates are preferably isocyanates having 4 to 20 C atoms. Examples of typical diisocyanates are aliphatic diisocyanates such as tetramethylene diisocyanate, pentamethylene 1,5-diisocyanate, hexamethylene diisocyanate (1,6-diisocyanatohexane), octamethylene diisocyanate, decamethylene diisocyanate, dodecamethylene diisocyanate, tetradecamethylene diisocyanate, derivatives of lysine diisocyanate (e.g., methyl 2,6-diisocyanatohexanoate or ethyl 2,6-diisocyanatohexanoate), trimethylhexane diisocyanate or tetramethylhexane diisocyanate, cycloaliphatic diisocyanates such as 1,4-, 1,3- or 1,2-diisocyanatocyclohexane, 4,4′- or 2,4′-di(isocyanatocyclohexyl)methane, 1-isocyanato-3,3,5-trimethyl-5-(isocyanatomethyl)cyclohexane (isophorone diisocyanate), 1,3- or 1,4-bis(isocyanatomethyl)cyclohexane or 2,4-, or 2,6-diisocyanato-1-methylcyclohexane, and also 3 (or 4), 8 (or 9)-bis(isocyanatomethyl)tricyclo[5.2.1.0^{2.6}]decane isomer mixtures, and also aromatic diisocyanates such as tolylene 2,4- or 2,6-diisocyanate and the isomer mixtures thereof, m- or p-xylylene diisocyanate, 2,4′- or 4,4′-diisocyanatodiphenylmethane and the isomer mixtures thereof, phenylene 1,3- or 1,4-diisocyanate, 1-chlorophenylene 2,4-diisocyanate, naphthylene 1,5-diisocyanate, diphenylene 4,4′-diisocyanate, 4,4′-diisocyanato-3,3′-dimethylbiphenyl, 3-methyldiphenylmethane 4,4′-diisocyanate, tetramethylxylylene diisocyanate, 1,4-diisocyanatobenzene or diphenyl ether 4,4′-diisocyanate.

Particular preference is given to hexamethylene 1,6-diisocyanate, 1,3-bis(isocyanato-methyl)cyclohexane, isophorone diisocyanate, and 4,4′- or 2,4′-di(isocyanato-cyclohexyl)methane, very particular preference to isophorone diisocyanate and hexamethylene 1,6-diisocyanate, and especial preference to hexamethylene 1,6-diisocyanate.

Mixtures of said isocyanates may also be present.

Isophorone diisocyanate is usually in the form of a mixture, specifically a mixture of the cis and trans isomers, generally in a proportion of about 60:40 to 90:10 (w/w), preferably of 70:30-90:10.

Dicyclohexylmethane 4,4′-diisocyanate may likewise be in the form of a mixture of the different cis and trans isomers.

For the present invention it is possible to use not only those diisocyanates obtained by phosgenating the corresponding amines but also those prepared without the use of phosgene, i.e., by phosgene-free processes. According to EP-A-0 126 299 (U.S. Pat. No. 4,596,678), EP-A-126 300 (U.S. Pat. No. 4,596,679), and EP-A-355 443 (U.S. Pat. No. 5,087,739), for example, (cyclo)aliphatic diisocyanates, such as hexamethylene 1,6-diisocyanate (HDI), isomeric aliphatic diisocyanates having 6 carbon atoms in the alkylene radical, 4,4′- or 2,4′-di(isocyanatocyclohexyl)methane, and 1-isocyanato-3-isocyanatomethyl-3,5,5-trimethylcyclohexane (isophorone diisocyanate or IPDI) can be prepared by reacting the (cyclo)aliphatic diamines with, for example, urea and alcohols to give (cyclo)aliphatic biscarbamic esters and subjecting said esters to thermal cleavage into the corresponding diisocyanates and alcohols. The synthesis takes place usually continuously in a circulation process and optionally in the presence of N-unsubstituted carbamic esters, dialkyl carbonates, and other by-products recycled from the reaction process. Diisocyanates obtained in this way generally contain a very low or even unmeasurable fraction of chlorinated compounds, which is advantageous, for example, in applications in the electronics industry.

In one embodiment of the present invention the isocyanates used have a hydrolyzable chlorine content of less than 100 ppm, preferably of less than 50 ppm, in particular less than 30 ppm, and especially less than 20 ppm. This can be measured by means, for example, of ASTM specification D4663-98. The total chlorine contents are, for example below 1000 ppm, preferably below 800 ppm, and more preferably below 500 ppm (determined by argentometric titration after hydrolysis).

It will be appreciated that it is also possible to employ mixtures of those monomeric isocyanates which have been obtained by reacting the (cyclo)aliphatic diamines with, for example, urea and alcohols and cleaving the resulting (cyclo)aliphatic biscarbamic esters, with those diisocyanates which have been obtained by phosgenating the corresponding amines.

The polyisocyanates (A) which can be formed by oligomerizing the monomeric isocyanates are generally characterized as follows:

The average NCO functionality of such compounds is in general at least 1.8 and can be up to 8, preferably 2 to 5, and more preferably 2.4 to 4.

The isocyanate group content after oligomerization, calculated as NCO=42 g/mol, is generally from 5% to 25% by weight unless otherwise specified.

The polyisocyanates (A) are preferably compounds as follows:
1) Polyisocyanates containing isocyanurate groups, of aromatic, aliphatic and/or cycloaliphatic diisocyanates. Particular preference is given in this context to the corresponding aliphatic and/or cycloaliphatic isocyanatoisocyanurates and in particular to those based on hexamethylene diisocyanate and isophorone diisocyanate. The isocyanurates present are, in particular, trisisocyanatoalkyl and/or trisisocyanatocycloalkyl isocyanurates, which constitute cyclic trimers of the diisocyanates, or are mixtures with their higher homologs containing more than one isocyanurate ring. The isocyanatoisocyanurates generally have an NCO content of 10% to 30% by weight, in particular 15% to 25% by weight, and an average NCO functionality of 2.6 to 8.
   The polyisocyanates containing isocyanurate groups may to a relatively minor degree also contain urethane groups and/or allophanate groups, preferably with a bound alcohol content of less than 2%, based on the polyisocyanate.
2) Polyisocyanates containing uretdione groups and having aromatically, aliphatically and/or cycloaliphatically attached isocyanate groups, preferably aliphatically and/or cycloaliphatically attached, and in particular those derived from hexamethylene diisocyanate or isophorone diisocyanate. Uretdione diisocyanates are cyclic dimerization products of diisocyanates.
   The polyisocyanates containing uretdione groups are obtained often as a mixture with other polyisocyanates, more particularly those specified under 1). Polyisocyanates containing uretdione groups typically have functionalities of 2 to 3.
   This also includes uretdione/isocyanurate mixtures of any desired composition, more particularly those having a monomeric uretdione (dimer) content of 1-40%, more particularly 3-15%, more particularly 5-10%.
   For this purpose the diisocyanates can be reacted under reaction conditions under which not only uretdione groups but also the other polyisocyanates are formed, or the uretdione groups are formed first of all and are subsequently reacted to give the other polyisocyanates, or the diisocyanates are first reacted to give the other polyisocyanates, which are subsequently reacted to give products containing uretdione groups.
3) Polyisocyanates containing biuret groups and having aromatically, cycloaliphatically or aliphatically attached, preferably cycloaliphatically or aliphatically attached, isocyanate groups, especially tris(6-isocyanatohexyl)biuret or its mixtures with its higher homologs. These polyisocyanates containing biuret groups generally have an NCO content of 18% to 24% by weight and an average NCO functionality of 2.8 to 6.
4) Polyisocyanates containing urethane and/or allophanate groups and having aromatically, aliphatically or cycloaliphatically attached, preferably aliphatically or cycloaliphatically attached, isocyanate groups, such as may be obtained, for example, by reacting excess amounts of diisocyanate, such as of hexamethylene diisocyanate or of isophorone diisocyanate, with mono- or polyhydric alcohols. These polyisocyanates containing urethane and/or allophanate groups generally have an NCO content of 12% to 24% by weight and an average NCO functionality of 2.0 to 4.5. Polyisocyanates of this kind containing urethane and/or allophanate groups may be prepared without catalyst or, preferably, in the presence of catalysts, such as ammonium carboxylates or ammonium hydroxides, for example, or allophanatization catalysts, e.g., bismuth, cobalt, cesium, Zn(II) or Zr(IV) compounds, for example, in each case in the presence of monohydric, dihydric or polyhydric, preferably monohydric, alcohols.
   These polyisocyanates containing urethane groups and/or allophanate groups occur frequently in mixed forms with the polyisocyanates specified under 1).
5) Polyisocyanates comprising oxadiazinetrione groups, derived preferably from hexamethylene diisocyanate or isophorone diisocyanate. Polyisocyanates of this kind comprising oxadiazinetrione groups are accessible from diisocyanate and carbon dioxide.
6) Polyisocyanates comprising iminooxadiazinedione groups, derived preferably from hexamethylene diisocyanate or isophorone diisocyanate. Polyisocyanates of this kind comprising iminooxadiazinedione groups are preparable from diisocyanates by means of specific catalysts.
7) Uretonimine-modified polyisocyanates.
8) Carbodiimide-modified polyisocyanates.
9) Hyperbranched polyisocyanates, of the kind known for example from DE-A110013186 or DE-A110013187.
10) Polyurethane-polyisocyanate prepolymers, from di- and/or polyisocyanates with alcohols.
11) Polyurea-polyisocyanate prepolymers.
12) The polyisocyanates 1)-11), preferably 1), 3), 4), and 6), can be converted, following their preparation, into polyisocyanates containing biuret groups or urethane/allophanate groups and having aromatically, cycloaliphatically or aliphatically attached, preferably (cyclo)aliphatically attached, isocyanate groups. The formation of biuret groups is accomplished, for example, by addition of water or by reaction with amines. The formation of urethane and/or allophanate groups is accomplished by reaction with monohydric, dihydric or polyhydric, preferably monohydric, alcohols, optionally in the presence of suitable catalysts. These polyisocyanates containing biuret or urethane/allophanate groups generally have an NCO content of 10% to 25% by weight and an average NCO functionality of 3 to 8.
13) Hydrophilically modified polyisocyanates, i.e., polyisocyanates which as well as the groups described under 1-12 also comprise groups which result formally from addition of molecules containing NCO-reactive groups and hydrophilizing groups to the isocyanate groups of the above molecules. The latter groups are nonionic groups such as alkylpolyethylene oxide and/or ionic groups derived from phosphoric acid, phosphonic acid, sulfuric acid or sulfonic acid, and/or their salts.
14) Modified polyisocyanates for dual cure applications, i.e., polyisocyanates which as well as the groups described under 1-11 also comprise groups resulting formally from addition of molecules containing NCO-reactive groups and UV-crosslinkable or actinic-radiation-crosslinkable groups to the isocyanate groups of the above molecules. These molecules are, for example, hydroxyalkyl (meth)acrylates and other hydroxy-vinyl compounds.

The diisocyanates or polyisocyanates recited above may also be present at least partly in blocked form.

Classes of compounds used for blocking are described in D. A. Wicks, Z. W. Wicks, Progress in Organic Coatings, 36, 148-172 (1999), 41, 1-83 (2001), and also 43, 131-140 (2001).

Examples of classes of compounds used for blocking are phenols, imidazoles, triazoles, pyrazoles, oximes, N-hydroxyimides, hydroxybenzoic esters, secondary amines, lactams, CH-acidic cyclic ketones, malonic esters or alkyl acetoacetates.

In one preferred embodiment of the present invention the polyisocyanate is selected from the group consisting of isocyanurates, biurets, urethanes, and allophanates, preferably from the group consisting of isocyanurates, urethanes, and allophanates; with particular preference it is a polyisocyanate containing isocyanurate groups.

In one particularly preferred embodiment the polyisocyanate encompasses polyisocyanates comprising isocyanurate groups and obtained from hexamethylene 1,6-diisocyanate.

In one further preferred embodiment the polyisocyanate encompasses a mixture of polyisocyanates comprising isocyanurate groups and obtained very preferably from hexamethylene 1,6-diisocyanate and from isophorone diisocyanate.

In one particularly preferred embodiment the polyisocyanate is a mixture comprising low-viscosity polyisocyanates, preferably polyisocyanates comprising isocyanurate groups, having a viscosity of 600-1500 mPa*s, more particularly below 1200 mPa*s, low-viscosity urethanes and/or allophanates having a viscosity of 200-1600 mPa*s, more particularly 600-1500 mPa*s, and/or polyisocyanates comprising iminooxadiazinedione groups.

In this specification, unless noted otherwise, the viscosity is reported at 23° C. in accordance with DIN EN ISO 3219/A.3 in a cone/plate system with a shear rate of 1000 s⁻¹.

The process for preparing the polyisocyanates may take place as described in WO 2008/68198, especially from page 20 line 21 to page 27 line 15 therein, which is hereby made part of the present specification by reference.

The reaction can be discontinued, for example, as described therein from page 31 line 19 to page 31 line 31, and working up may take place as described therein from page 31 line 33 to page 32 line 40, which in each case is hereby made part of the present specification by reference.

The reaction can alternatively and preferably be effected as described in WO 2005/087828 for ammonium alpha-hydroxycarboxylate catalysts. Express reference is hereby made to the ammonium α-hydroxycarboxylates described in WO 2005/87828 at page 3 line 29 to page 6 line 7.

Mention may be made more particularly as ammonium cations of tetraoctylammonium, tetramethylammonium, tetraethylammonium, tetra-n-butylammonium, trimethylbenzyl-ammonium, triethylbenzylammonium, tri-n-butylbenzylammonium, trimethylethylammonium, tri-n-butylethylammonium, triethylmethylammonium, tri-n-butylmethylammonium, diisopropyl-diethylammonium, diisopropylethylmethylammonium, diisopropylethylbenzylammonium, N,N-dimethylpiperidinium, N,N-dimethylmorpholinium, N,N-dimethylpiperazinium or N-methyl-diazabicyclo[2.2.2]octane. Preferred alkyl ammonium ions are tetraoctylammonium, tetramethylammonium, tetraethylammonium, and tetra-n-butylammonium, more preferably tetramethylammonium and tetraethylammonium, and very preferably tetramethylammonium and benzyltrimethylammonium.

Mention may be made more particularly as α-hydroxycarboxylates of glycolic acid (hydroxyacetic acid), lactic acid, citric acid, 2-methyllactic acid (α-hydroxyisobutyric acid), 2-hydroxy-2-methylbutyric acid, 2-hydroxy-2-ethylbutyric acid, 2-hydroxy-3-methylbutyric acid, 2-hydroxycaproic acid, maleic acid, tartaric acid, glucuronic acid, gluconic acid, citramalic acid, saccharic acid, ribonic acid, benzylic acid, china acid, mandelic acid, hexahydromandelic acid, 2-hydroxycaproic acid or 3-phenyllactic acid. Preferred α-hydroxycarboxylates are lactic acid, 2-methyllactic acid, (α-hydroxyisobutyric acid), 2-hydroxy-2-methylbutyric acid, and 2-hydroxy-caproic acid, more preferably lactic acid, 2-methyllactic acid (α-hydroxyisobutyric acid), and 2-hydroxycaproic acid, and very preferably α-hydroxyisobutyric acid and lactic acid.

The reaction may be discontinued for example as described therein from page 11 line 12 to page 12 line 5, hereby made part of the present specification by reference.

The reaction may alternatively take place as described in CN 10178994A or CN 101805304.

In the case of thermally labile catalysts it is also possible, furthermore, to terminate the reaction by heating of the reaction mixture to a temperature above at least 80° C., preferably at least 100° C., more preferably at least 120° C.

In the case both of thermally non-labile catalysts and of thermally labile catalysts, the possibility exists of terminating the reaction at relatively low temperatures by addition of deactivators. Deactivators can also be added stoichiometrically in deficit to the catalyst, if the catalyst is at least partly thermally destroyed or the product is stable in viscosity on subsequent storage (e.g., undergoes no more than a threefold increase in viscosity on storage of the 100% form over 10 weeks at 80° C. under nitrogen). Examples of suitable deactivators are hydrogen chloride, phosphoric acid, organic phosphates, such as dibutyl phosphate or diethylhexyl phosphate, phosphonates such as dioctyl phosphonate, and carbamates such as hydroxyalkyl carbamate. Dibutyl or diethylhexyl phosphate is preferred.

These compounds are added neat or diluted in a suitable concentration as necessary to discontinue the reaction. Examples of suitable solvents are the monomer, alcohols such as ethylhexanol or methyl glycol, or polar, aprotic solvents such as propylene carbonate.

Examples of suitable Lewis-acidic organometallic compounds (B) are tin compounds, such as tin(II) salts of organic carboxylic acids, e.g., tin(II) diacetate, tin(II) dioctoate, tin(II) bis(ethylhexanoate), and tin(II) dilaurate, and the dialkyltin(IV) salts of organic carboxylic acids, e.g., dimethyltin diacetate, dibutyltin diacetate, dibutyltin dibutyrate, dibutyltin bis(2-ethylhexanoate), dibutyltin dilaurate, dibutyltin maleate, dioctyltin dilaurate, and dioctyltin diacetate.

Other preferred Lewis-acidic organometallic compounds are zinc salts, example being zinc(II) diacetate and zinc(II) dioctoate.

Tin-free and zinc-free alternatives used include organometallic salts of bismuth, zirconium, titanium, aluminum, iron, manganese, nickel, and cobalt.

These are, for example, zirconium tetraacetylacetonate (e.g., K-KAT® 4205 from King Industries); zirconium dionates (e.g., K-KAT® XC-9213; XC-A 209 and XC-6212 from King Industries); bismuth compounds, especially tricarboxylates (e.g., K-KAT® 348, XC-B221; XC-C227, XC 8203 from King Industries); aluminum dionate (e.g., K-KAT® 5218 from King Industries). Tin-free and zinc-free catalysts are otherwise also offered, for example, under the trade name Borchi® Kat from Borchers, TK from Goldschmidt or BICAT® from Shepherd, Lausanne.

Bismuth catalysts and cobalt catalysts as well, cerium salts such as cerium octoates, and cesium salts can be used as catalysts.

Bismuth catalysts are more particularly bismuth carboxylates, especially bismuth octoates, ethylhexanoates, neodecanoates, or pivalates; examples are K-KAT 348 and XK-601 from King Industries, TIB KAT 716, 716LA, 716XLA, 718, 720, 789 from TIB Chemicals, and those from Shepherd Lausanne, and also catalyst mixtures of, for example, bismuth organyls and zinc organyls.

Further metal catalysts are described by Blank et al. in Progress in Organic Coatings, 1999, Vol. 35, pages 19-29.

These catalysts are suitable for solvent-based, water-based and/or blocked systems.

Molybdenum, tungsten, and vanadium catalysts are described more particularly for the reaction of blocked polyisocyanates in WO 2004/076519 and WO 2004/076520.

Cesium salts as well can be used as catalysts. Suitable cesium salts are those compounds in which the following anions are employed: F⁻, Cl⁻, ClO⁻, ClO₃⁻, ClO₄⁻, Br⁻, I⁻, IO₃⁻, CN⁻, OCN⁻, NO₂⁻, NO₃⁻, HCO₃⁻, CO₃²⁻, S²⁻, SH⁻, HSO₃⁻, SO₃²⁻, HSO₄⁻, SO₄²⁻, S₂O₂²⁻, S₂O₄²⁻, S₂O₅²⁻, S₂O₆²⁻, S₂O₇²⁻, S₂O₈²⁻, H₂PO₂⁻, H₂PO₄⁻, HPO₄²⁻, PO₄³⁻, P₂O₇⁴⁻, (OCₙH₂ₙ₊₁)⁻, (CₙH₂ₙ₋₁O₂)⁻, (CₙH₂ₙ₋₃O₂)⁻, and also (Cₙ₊₁H₂ₙ₋₂O₄)²⁻, where n stands for the numbers 1 to 20. Preferred here are cesium carboxylates in which the anion conforms to the formulae (CₙH₂ₙ₋₁O₂)⁻ and also (Cₙ₊₁H₂ₙ₋₂O₄)²⁻, with n being 1 to 20. Particularly preferred cesium salts contain monocarboxylate anions of the general formula (CₙH₂ₙ₋₁O₂)⁻, with n standing for the numbers 1 to 20. Particular mention in this context is deserved by formate, acetate, propionate, hexanoate, and 2-ethylhexanoate. Preferred Lewis-acidic organometallic compounds are dimethyltin diacetate, dibutyltin dibutyrate, dibutyltin bis(2-ethylhexanoate), dibutyltin dilaurate, dioctyltin dilaurate, zinc(II) diacetate, zinc(II) dioctoate, zirconium acetylacetonate, and zirconium 2,2,6,6-tetramethyl-3,5-heptanedionate, and bismuth compounds.

Particular preference is given to dibutyltin dilaurate.

Brønsted acids (C) are H-acidic compounds. They are preferably C1) dialkyl phosphates, C2) arylsulfonic acids and/or C3) phosphonates.

Dialkyl phosphates C1 are mono- and di-C₁ to C₁₋₂ alkyl phosphates and mixtures thereof, preferably the dialkyl phosphates, more preferably those having C₁ to C₈ alkyl groups, very preferably having C₂ to C₈ alkyl groups, and more particularly those having C₄ to C₈ alkyl groups.

The alkyl groups in dialkyl phosphates here may be identical or different, and are preferably identical.

Examples of C₁ to C₁₂ alkyl groups are methyl, ethyl, isopropyl, n-propyl, n-butyl, isobutyl, sec-butyl, tert-butyl, n-hexyl, n-heptyl, n-octyl, n-decyl, n-dodecyl, 2-ethylhexyl, and 2-propylheptyl.

These phosphates are more particularly monoalkyl and dialkyl phosphates and mixtures thereof such as
di(ethylhexyl)phosphate
dibutyl phosphate
diethyl phosphate
Nacure® 4000 (formerly Nacure® C 207), an unspecified alkylphosphoric ester, from King Industries
Nacure® 4054, an unspecified alkylphosphoric ester, from King Industries
Cycat® 296-9, an unspecified alkylphosphoric ester, from Cytec

Preferred for use in polyisocyanates is use in the form of a 100% product or in a solvent which does not react with isocyanate groups.

Compounds C1 are added generally in amounts, based on the polyisocyanate, of 5 to 1000, preferably 10 to 600, more preferably 20 to 200, very preferably 20 to 80 ppm by weight.

Arylsulfonic acids C2 are, for example, benzene derivatives or naphthalene derivatives, more particularly alkylated benzene or naphthalene derivatives.

Examples of preferred sulfonic acids include 4-alkylbenzenesulfonic acids having alkyl radicals of 6 to 12 C atoms, such as, for example, 4-hexylbenzenesulfonic acid, 4-octylbenzenesulfonic acid, 4-decylbenzenesulfonic acid or 4-dodecylbenzenesulfonic acid. In a manner which is known in principle, the compounds in question here may also be technical products which feature a distribution of different alkyl radicals of different lengths.

Particularly preferred acids include the following:
benzenesulfonic acid
para-toluenesulfonic acid
para-ethylbenzenesulfonic acid
dodecylbenzenesulfonic acid
bisnonylnaphthalenesulfonic acid
bisnonylnaphthalenebissulfonic acid
bisdodecylnaphthalenesulfonic acid
Nacure® XC-C210 (a hydrophobic acid catalyst of unspecified structure from King Industries)

Compounds C1 are added in general in amounts, based on the polyisocyanate, of 1 to 600, preferably 2 to 100, more preferably 5 to 50 ppm by weight.

Phosphonates C3 are phosphorus-containing compounds with a low functionality and an acidic character, more particularly dialkyl phosphonates C3a) and dialkyl diphosphonates C3b).

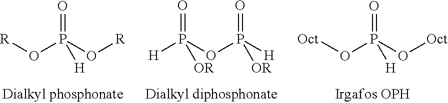

Examples thereof are mono- and di-C₁ to C₁₂ alkyl phosphonates and mixtures thereof, preferably the dialkyl phosphonates, more preferably those having C₁ to C₈ alkyl groups, very preferably having C₁ to C₈ alkyl groups, and more particularly those having C₁, C₂, C₄ or C₈ alkyl groups.

The alkyl groups in dialkyl phosphonates may be identical or different, and are preferably identical.

Examples of C₁ to C₁₂ alkyl groups are methyl, ethyl, isopropyl, n-propyl, n-butyl, isobutyl, sec-butyl, tert-butyl, n-hexyl, n-heptyl, n-octyl, n-decyl, n-dodecyl, 2-ethylhexyl, and 2-propylheptyl.

The examples described in WO 2008/116895 are hereby part of the present disclosure content. Specific examples that may explicitly be given include the following:
dioctyl phosphonate, di-n-octyl phosphonate Irgafos® OPH (see image above)
di-(2-ethylhexyl) phosphonate
diethyl phosphonate

Compounds C3 are generally in amounts, based on the polyisocyanate, of 10 to 1000, preferably 20 to 600, more preferably 50 to 300 ppm by weight.

Sterically hindered phenols (D) have the function in the sense of the invention of a primary antioxidant. This is a term commonly used by the skilled person to refer to compounds which scavenge free radicals.

Sterically hindered phenols (D) of this kind are described in WO 2008/116894, for example, preference being given to the compounds described therein at page 14 line 10 to page 16 line 10, hereby made part of the present disclosure content by reference.

The phenols in question are preferably those which have exactly one phenolic hydroxyl group on the aromatic ring, and more preferably those which have a substituent, preferably an alkyl group, in the ortho-positions, very preferably in ortho-position and para-position, to the phenolic hydroxyl group, preferably contain an alkyl group, and more particularly are alkyl 3-(3,5-di-tert-butyl-4-hydroxyphenyl)propionates, or substituted alkyl derivatives of such compounds.

Phenols of this kind may also be constituents of a polyphenolic system having a plurality of phenol groups: pentaerythritol tetrakis(3-(3,5-di-tert-butyl-4-hydroxyphenyl)propionate (e.g., Irganox® 1010); ethylenebis(oxyethylene) bis(3-(5-tert-butyl-4-hydroxy-m-tolyl)propionate) (e.g., Irganox 245); 3,3′,″, 5,5′,5″-hexa-tert-butyl-a,a′,a″-(mesitylene-2,4,6-triyl)tri-p-cresol (e.g., Irganox® 1330); 1,3,5-tris(3,5-di-tert-butyl-4-hydroxybenzyl)-1,3,5-triazine-2,4,6(1H,3H,5H)-trione (e.g., Irganox® 3114), in each case products of Ciba Spezialitätenchemie, now BASF SE.

Corresponding products are available, for example, under the trade names Irganox® (BASF SE), Sumilizer® from Sumitomo, Lowinox® from Great Lakes, and Cyanox® from Cytec.

Also possible are, for example, thiodiethylenebis[3-[3,5-di-tert-butyl-4-hydroxyphenyl]propionate] (Irganox® 1035) and 6,6′-di-tert-butyl-2,2′-thiodi-p-cresol (e.g., Irganox® 1081), each products of BASF SE.

Preference is given to 2,6-di-tert-butyl-4-methylphenol (BHT); isooctyl 3-(3,5-di-tert-butyl-4-hydroxyphenyl)propionate (Irganox® 1135, CAS No. 146598-26-7), octadecyl 3-(3,5-di-tert-butyl-4-hydroxyphenyl)propionate (Irganox® 1076, CAS No. 2082-79-3), and pentaerythritol tetrakis(3-(3,5-di-tert-butyl-4-hydroxyphenyl)propionate (CAS No. 6683-19-8; e.g., Irganox® 1010).

It is possible as well, furthermore, for a solvent or solvent mixture (E) to be present.

Solvents which can be used for the polyisocyanate component, and also for the binder and any other components, are those which contain no groups that are reactive toward isocyanate groups or blocked isocyanate groups, and in which the polyisocyanates are soluble to an extent of at least 10%, preferably at least 25%, more preferably at least 50%, very preferably at least 75%, more particularly at least 90%, and especially at least 95% by weight.

Examples of solvents of this kind are aromatic hydrocarbons (including alkylated benzenes and naphthalenes) and/or (cyclo)aliphatic hydrocarbons and mixtures thereof, chlorinated hydrocarbons, ketones, esters, alkoxylated alkyl alkanoates, ethers, and mixtures of the solvents.

Preferred aromatic hydrocarbon mixtures are those which comprise predominantly aromatic C₇ to C₁₄ hydrocarbons and may encompass a boiling range from 110 to 300° C.; particular preference is given to toluene, o-, m- or p-xylene, trimethylbenzene isomers, tetramethylbenzene isomers, ethylbenzene, cumene, tetrahydronaphthalene, and mixtures comprising them.

Examples thereof are the Solvesso® products from ExxonMobil Chemical, especially Solvesso® 100 (CAS No. 64742-95-6, predominantly C₉ and C₁₀ aromatics, boiling range about 154-178° C.), 150 (boiling range about 182-207° C.), and 200 (CAS No. 64742-94-5), and also the Shellsol® products from Shell, Caromax® (e.g., Caromax® 18) from Petrochem Carless, and Hydrosol from DHC (e.g., as Hydrosol® A 170). Hydrocarbon mixtures comprising paraffins, cycloparaffins, and aromatics are also available commercially under the names Kristalloel (for example, Kristalloel 30, boiling range about 158-198° C. or Kristalloel 60: CAS No. 64742-82-1), white spirit (for example likewise CAS No. 64742-82-1) or solvent naphtha (light: boiling range about 155-180° C., heavy: boiling range about 225-300° C.). The aromatics content of such hydrocarbon mixtures is generally more than 90%, preferably more than 95%, more preferably more than 98%, and very preferably more than 99% by weight. It may be advisable to use hydrocarbon mixtures having a particularly reduced naphthalene content.

Examples of (cyclo)aliphatic hydrocarbons include decalin, alkylated decalin, and isomer mixtures of linear or branched alkanes and/or cycloalkanes.

The amount of aliphatic hydrocarbons is generally less than 5%, preferably less than 2.5%, and more preferably less than 1% by weight.

Esters are, for example, n-butyl acetate, ethyl acetate, 1-methoxyprop-2-yl acetate, and 2-methoxyethyl acetate.

Ethers are, for example, THF, dioxane, and also the dimethyl, diethyl or di-n-butyl ethers of ethylene glycol, diethylene glycol, triethylene glycol, propylene glycol, dipropylene glycol or tripropylene glycol.

Ketones are, for example, acetone, diethyl ketone, ethyl methyl ketone, isobutyl methyl ketone, methyl amyl ketone and tert-butyl methyl ketone.

Preferred solvents are n-butyl acetate, ethyl acetate, 1-methoxyprop-2-yl acetate, 2-methoxyethyl acetate, and also mixtures thereof, more particularly with the aromatic hydrocarbon mixtures recited above, especially xylene and Solvesso® 100.

Mixtures of this kind may be prepared in a volume ratio of 5:1 to 1:5, preferably in a volume ratio of 4:1 to 1:4, more preferably in a volume ratio of 3:1 to 1:3, and very preferably in a volume ratio of 2:1 to 1:2.

Preferred examples are butyl acetate/xylene, methoxypropyl acetate/xylene 1:1, butyl acetate/solvent naphtha 100 1:1, butyl acetate/Solvesso® 100 1:2, and Kristalloel 30/Shellsol® A 3:1.

Preference is given to butyl acetate, 1-methoxyprop-2-yl acetate, methyl amyl ketone, xylene, and Solvesso® 100.

Surprisingly it has been found that the solvents are differently problematic in relation to the stated object. Polyisocyanate compositions as per the patent which comprise ketones or mixtures of aromatics (solvent naphtha mixtures, for example) are particularly critical in respect of development of color number on storage. In contrast, esters, ethers, and certain aromatics cuts such as xylene and its isomer mixtures are less problematic. This is surprising insofar as xylenes, in the same way as the mixtures of aromatics, likewise carry benzylic hydrogen atoms, which could play a part in the development of color. A further factor is that solvent naphtha mixtures, depending on the source and storage time, can have significantly different effects on color number drift if used in the polyisocyanate compositions.

Further, typical coatings additives (F) used may be the following, for example: other antioxidants, UV stabilizers such as UV absorbers and suitable free-radical scavengers (especially HALS compounds, hindered amine light stabilizers), activators (accelerators), drying agents, fillers, pigments, dyes, antistatic agents, flame retardants, thickeners, thixotropic agents, surface-active agents, viscosity modifiers, plasticizers or chelating agents. UV stabilizers are preferred.

Other primary antioxidants are, for example, secondary arylamines.

The secondary antioxidants are preferably selected from the group consisting of phosphites, phosphonites, phosphonates, and thioethers.

Phosphites are compounds of the type P(OR^{a})(OR^{b}) (OR^{c}) with R^{a}, R^{b}, and R^{c} being identical or different, aliphatic or aromatic radicals (which may also form cyclic or spiro structures).

Preferred phosphonites are described in WO 2008/116894, particularly from page 11 line 8 to page 14 line 8 therein, hereby made part of the present disclosure content by reference.

Preferred phosphonates are described in WO 2008/116895, particularly from page 10 line 38 to page 12 line 41 therein, hereby made part of the present disclosure content by reference.

These are more particularly dialkyl phosphonates and dialkyl diphosphonates.

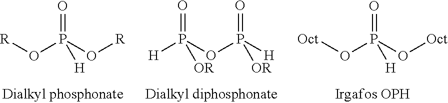

Examples thereof are mono- and di-C₁ to C₁₋₂ alkyl phosphonates and mixtures thereof, preferably the dialkyl phosphonates, more preferably those having C₁ to C8 alkyl groups, very preferably having C₁ to C₈ alkyl groups, and more particularly those having C₁, C₂, C₄ or C8 alkyl groups.

The alkyl groups in dialkyl phosphonates may be identical or different, and are preferably identical.

Examples of C₁ to C₁₂ alkyl groups are methyl, ethyl, isopropyl, n-propyl, n-butyl, isobutyl, sec-butyl, tert-butyl, n-hexyl, n-heptyl, n-octyl, n-decyl, n-dodecyl, 2-ethylhexyl, and 2-propylheptyl, more particularly di-n-octyl phosphonate Irgafos® OPH (see image above), and di-(2-ethylhexyl) phosphonate.

Preferred thioethers described in WO 2008/116893, particularly from page 11 line 1 to page 15 line 37 therein, hereby made part of the present disclosure content by reference.

Suitable UV absorbers comprise oxanilides, triazines and benzotriazole (the latter available, for example, as Tinuvin® products from BASF SE) and benzophenones (e.g., Chimassorb® 81 from BASF SE). Preference is given, for example, to 95% benzenepropanoic acid, 3-(2H-benzotriazol-2-yl)-5-(1,1-dimethylethyl)-4-hydroxy-, C₇₋₉-branched and linear alkyl esters; 5% 1-methoxy-2-propyl acetate (e.g., Tinuvin® 384) and α-[3-[3-(2H-benzotriazol-2-yl)-5-(1,1-dimethylethyl)-4-hydroxyphenyl]-1-oxopropyl]-ω-hydroxypoly(oxo-1,2-ethanediyl) (e.g., Tinuvin® 1130), in each case products, for example, of BASF SE. DL-alpha-Tocopherol, tocopherol, cinnamic acid derivatives, and cyanoacrylates can likewise be used for this purpose.

These can be employed alone or together with suitable free-radical scavengers, examples being sterically hindered amines (often also identified as HALS or HAS compounds; hindered amine (light) stabilizers) such as 2,2,6,6-tetramethylpiperidine, 2,6-di-tert-butylpiperidine or derivatives thereof, e.g., bis(2,2,6,6-tetramethyl-4-piperidyl) sebacate. They are obtainable, for example, as Tinuvin® products and Chimassorb® products from BASF SE. Preference in joint use with Lewis acids, however, is given to those hindered amines which are N-alkylated, examples being bis(1,2,2,6,6-pentamethyl-4-piperidinyl) [[3,5-bis(1,1-dimethylethyl)-4-hydroxyphenyl]methyl]butylmalonate (e.g., Tinuvin® 144 from BASF SE); a mixture of bis(1,2,2,6,6-pentamethyl-4-piperidinyl)sebacate and methyl(1,2,2,6,6-pentamethyl-4-piperidinyl) sebacate (e.g., Tinuvin® 292 from BASF SE); or which are N—(O-alkylated), such as, for example, decanedioic acid bis(2,2,6,6-tetramethyl-1-(octyloxy)-4-piperidinyl) ester, reaction products with 1,1-dimethylethyl hydroperoxide and octane (e.g., Tinuvin® 123 from BASF SE) and especially the HALS triazine “2-aminoethanol, reaction products with cyclohexane and peroxidized N-butyl-2,2,6,6-tetramethyl-4-piperidinamine-2,4,6-trichloro-1,3,5-triazine reaction product” (e.g., Tinuvin® 152 from BASF SE).

UV stabilizers are used typically in amounts of 0.1% to 5.0% by weight, based on the solid components present in the preparation.

Suitable thickeners include, in addition to free-radically (co)polymerized (co)polymers, typical organic and inorganic thickeners such as hydroxymethylcellulose or bentonite.

Chelating agents which can be used include, for example, ethylenediamineacetic acid and salts thereof and also β-diketones.

As component (G) in addition it is possible for fillers, dyes and/or pigments to be present.

Pigments in the true sense are, according to CD Römpp Chemie Lexikon—Version 1.0, Stuttgart/New York: Georg Thieme Verlag 1995, with reference to DIN 55943, particulate “colorants that are organic or inorganic, chromatic or achromatic and are virtually insoluble in the application medium”.

Virtually insoluble here means a solubility at 25° C. below 1 g/1000 g application medium, preferably below 0.5, more preferably below 0.25, very particularly preferably below 0.1, and in particular below 0.05 g/1000 g application medium.

Examples of pigments in the true sense comprise any desired systems of absorption pigments and/or effect pigments, preferably absorption pigments. There are no restrictions whatsoever on the number and selection of the pigment components. They may be adapted as desired to the particular requirements, such as the desired perceived color, for example, as described in step a), for example. It is possible for example for the basis to be all the pigment components of a standardized mixer system.

Effect pigments are all pigments which exhibit a platelet-shaped construction and give a surface coating specific decorative color effects. The effect pigments are, for example, all of the pigments which impart effect and can be used typically in vehicle finishing and industrial coatings. Examples of such effect pigments are pure metallic pigments, such as aluminum, iron or copper pigments; interference pigments, such as titanium dioxide-coated mica, iron oxide-coated mica, mixed oxide-coated mica (e.g., with titanium dioxide and Fe₂O₃ or titanium dioxide and Cr₂O₃), metal oxide-coated aluminum; or liquid-crystal pigments, for example.

The coloring absorption pigments are, for example, typical organic or inorganic absorption pigments that can be used in the coatings industry. Examples of organic absorption pigments are azo pigments, phthalocyanine pigments, quinacridone pigments, and pyrrolopyrrole pigments. Examples of inorganic absorption pigments are iron oxide pigments, titanium dioxide, and carbon black.

Dyes are likewise colorants, and differ from the pigments in their solubility in the application medium; i.e., they have a solubility at 25° C. of more than 1 g/1000 g in the application medium.

Examples of dyes are azo, azine, anthraquinone, acridine, cyanine, oxazine, polymethine, thiazine, and triarylmethane dyes. These dyes may find application as basic or cationic dyes, mordant dyes, direct dyes, disperse dyes, development dyes, vat dyes, metal complex dyes, reactive dyes, acid dyes, sulfur dyes, coupling dyes or substantive dyes.

Coloristically inert fillers are all substances/compounds which on the one hand are coloristically inactive, i.e., exhibit a low intrinsic absorption and have a refractive index similar to that of the coating medium, and which on the other hand are capable of influencing the orientation (parallel alignment) of the effect pigments in the surface coating, i.e., in the applied coating film, and also properties of the coating or of the coating compositions, such as hardness or rheology, for example. Inert substances/compounds which can be used are given by way of example below, but without restricting the concept of coloristically inert, topology-influencing fillers to these examples. Suitable inert fillers meeting the definition may be, for example, transparent or semitransparent fillers or pigments, such as silica gels, blanc fixe, kieselguhr, talc, calcium carbonates, kaolin, barium sulfate, magnesium silicate, aluminum silicate, crystalline silicon dioxide, amorphous silica, aluminum oxide, microspheres or hollow microspheres made, for example, of glass, ceramic or polymers, with sizes of 0.1-50 μm, for example. Additionally as inert fillers it is possible to employ any desired solid inert organic particles, such as urea-formaldehyde condensates, micronized polyolefin wax and micronized amide wax, for example. The inert fillers can in each case also be used in a mixture. It is preferred, however, to use only one filler in each case.

Preferred fillers comprise silicates, examples being silicates obtainable by hydrolysis of silicon tetrachloride, such as Aerosil® from Degussa, siliceous earth, talc, aluminum silicates, magnesium silicates, calcium carbonates, etc.

In one preferred form, polyisocyanates (A) are made available for further processing in a first step in a blend with Lewis acid (B), Brønsted acid (C), sterically hindered phenol (D), optionally solvent(s) (E), and optionally additives (F). These mixtures are then converted, in a second step, into the polyisocyanate compositions of the invention, by addition of—optionally—further of components (B) to (F).

In another form of the invention, components A to E, optionally F and G are combined directly.

Preferred solvents for premixes of this first step are n-butyl acetate, ethyl acetate, 1-methoxyprop-2-yl acetate, 2-methoxyethyl acetate, and mixtures thereof, especially with the aromatic hydrocarbon mixtures set out above.

Mixtures of this kind can be produced in a volume ratio of 5:1 to 1:5, preferably in a volume ratio of 4:1 to 1:4, more preferably in a volume ratio of 3:1 to 1:3, and very preferably in a volume ratio of 2:1 to 1:2.

Preferred examples are butyl acetate/xylene, methoxypropyl acetate/xylene 1:1, butyl acetate/solvent naphtha 100 1:1, butyl acetate/Solvesso® 100 1:2, and Kristalloel 30/Shellsol® A 3:1.

The constitution of the polyisocyanate compositions of the invention is for example as follows:

(A) 20% to 99.998%, preferably 30% to 90%, more preferably 40-80% by weight,
(B) 10 to 10 000 ppm, preferably 20 to 2000 ppm, and more preferably 50 to 1000 ppm by weight,
(C) 2 to 1000 ppm, preferably 5 to 300 ppm, more preferably 10 to 50 ppm by weight,
(D) 20 to 2000 ppm, preferably 50 to 600 ppm, more preferably 100 to 200 ppm by weight, and
(E) 0% to 80%, preferably 10-70%, more preferably 20% to 60% by weight,
(F) 0-5% additives,
with the proviso that the sum always makes 100% by weight.
   (G) optionally pigments additionally to components (A) to (F) above.

Where components (G) are present, they are not included in the composition of components (A) to (F).

The polyisocyanate compositions of the invention can be used with advantage as curing agent components additionally to at least one binder in polyurethane coating materials.

The reaction with binders may take place, where appropriate, after a long period of time, necessitating storage of the polyisocyanate composition accordingly. Although polyisocyanate composition is stored preferably at room temperature, it can also be stored at higher temperatures. In industry, heating of such polyisocyanate compositions to 40° C., 60° C. and even up to 80° C. is entirely possible.

The binders may be, for example, polyacrylate polyols, polyester polyols, polyether polyols, polyurethane polyols; polyurea polyols; polyester-polyacrylate polyols; polyester-polyurethane polyols; polyurethane-polyacrylate polyols, polyurethane-modified alkyd resins; fatty acid-modified polyester-polyurethane polyols, copolymers with allyl ethers, graft polymers of the stated groups of compound having, for example, different glass transition temperatures, and also mixtures of the stated binders. Preference is given to polyacrylate polyols, polyester polyols, and polyurethane polyols.

Preferred OH numbers, measured in accordance with DIN 53240-2 (by potentiometry), are 40-350 mg KOH/g resin solids for polyesters, preferably 80-180 mg KOH/g resin solids, and 15-250 mg KOH/g resin solids for polyacrylateols, preferably 80-160 mg KOH/g.

Additionally the binders may have an acid number in accordance with DIN EN ISO 3682 (by potentiometry) of up to 200 mg KOH/g, preferably up to 150 and more preferably up to 100 mg KOH/g.

Particularly preferred binders are polyacrylate polyols and polyesterols.

Polyacrylate polyols preferably have a molecular weight Mₙ of at least 500, more preferably at least 1200 g/mol. The molecular weight Mₙ may in principle have no upper limit, and may preferably be up to 50 000, more preferably up to 20 000 g/mol, very preferably up to 10 000 g/mol, and more particularly up to 5000 g/mol.

The hydroxy-functional monomers (see below) are used in the copolymerization in amounts such as to result in the aforementioned hydroxyl numbers for the polymers, corresponding generally to a hydroxyl group content in the polymers of 0.5% to 8%, preferably 1% to 5% by weight.

These are hydroxyl-bearing copolymers of at least one hydroxyl-bearing (meth)acrylate with at least one further polymerizable comonomer selected from the group consisting of (meth)acrylic acid alkyl esters, vinylaromatics, α,β-unsaturated carboxylic acids, and other monomers.

Examples of (meth)acrylic acid alkyl esters include C₁-C₂₀ alkyl (meth)acrylates, vinylaromatics are those having up to 20 C atoms, α,β-unsaturated carboxylic acids also include their anhydrides, and other monomers are, for example, vinyl esters of carboxylic acids comprising up to 20 C atoms, ethylenically unsaturated nitriles, vinyl ethers of alcohols comprising 1 to 10 C atoms, and, less preferably, aliphatic hydrocarbons having 2 to 8 C atoms and 1 or 2 double bonds.

Preferred (meth)acrylic acid alkyl esters are those with a C₁-C₁₀ alkyl radical, such as methyl methacrylate, methyl acrylate, n-butyl acrylate, ethyl acrylate, and 2-ethylhexyl acrylate.

In particular, mixtures of the (meth)acrylic acid alkyl esters are also suitable.

Vinyl esters of carboxylic acids having 1 to 20 C atoms are, for example, vinyl laurate, vinyl stearate, vinyl propionate, and vinyl acetate. α,β-Unsaturated carboxylic acids and their anhydrides may for example be acrylic acid, methacrylic acid, fumaric acid, crotonic acid, itaconic acid, maleic acid or maleic anhydride, preferably acrylic acid.

As hydroxy-functional monomers, mention may be made of monoesters of α,β-unsaturated carboxylic acids, such as acrylic acid, methacrylic acid (identified for short in this specification as “(meth)acrylic acid”), with diols or polyols which have preferably 2 to 20 C atoms and at least two hydroxyl groups, such as ethylene glycol, diethylene glycol, triethylene glycol, 1,2-propylene glycol, 1,3-propylene glycol, 1,1-dimethyl-1,2-ethanediol, dipropylene glycol, triethylene glycol, tetraethylene glycol, pentaethylene glycol, tripropylene glycol, 1,4-butanediol, 1,5-pentanediol, neopentyl glycol, neopentyl glycol hydroxypivalate, 2-ethyl-1,3-propanediol, 2-methyl-1,3-propanediol, 2-butyl-2-ethyl-1,3-propanediol, 1,6-hexanediol, 2-methyl-1,5-pentanediol, 2-ethyl-1,4-butanediol, 2-ethyl-1,3-hexanediol, 2,4-diethyloctane-1,3-diol, 2,2-bis(4-hydroxycyclohexyl)propane, 1,1-, 1,2-, 1,3- and 1,4-bis(hydroxymethyl)cyclohexane, 1,2-, 1,3- or 1,4-cyclohexanediol, glycerol, trimethylolethane, trimethylolpropane, trimethylolbutane, pentaerythritol, ditrimethylolpropane, dipentaerythritol, sorbitol, mannitol, diglycerol, threitol, erythritol, adonitol (ribitol), arabitol (lyxitol), xylitol, dulcitol (galactitol), maltitol, isomalt, polyTHF with a molar weight between 162 and 4500, preferably 250 to 2000, poly-1,3-propanediol or polypropylene glycol with a molar weight between 134 and 2000, or polyethylene glycol with a molar weight between 238 and 2000.

Preference is given to 2-hydroxyethyl acrylate, 2-hydroxyethyl methacrylate, 2- or 3-hydroxypropyl acrylate, 1,4-butanediol monoacrylate or 3-(acryloyloxy)-2-hydroxypropyl acrylate, and particular preference to 2-hydroxyethyl acrylate and/or 2-hydroxyethyl methacrylate.

Vinylaromatic compounds contemplated include, for example, vinyltoluene, α-butylstyrene, α-methylstyrene, 4-n-butylstyrene, 4-n-decylstyrene, and—preferably—styrene.

Examples of nitriles are acrylonitrile and methacrylonitrile.

Suitable vinyl ethers are, for example, vinyl methyl ether, vinyl isobutyl ether, vinyl hexyl ether, and vinyl octyl ether.

Nonaromatic hydrocarbons having 2 to 8 C atoms and one or two olefinic double bonds include butadiene, isoprene, and also ethylene, propylene, and isobutylene.

Additionally possible for use are N-vinylformamide, N-vinylpyrrolidone, and N-vinylcaprolactam, and also ethylenically unsaturated acids, more particularly carboxylic acids, acid anhydrides or acid amides, and also vinylimidazole. Comonomers containing epoxide groups can be used as well, such as glycidyl acrylate or glycidyl methacrylate, for example, or monomers such as N-methoxymethylacrylamide or -methacrylamide, in minor amounts.

Preference is given to esters of acrylic acid and/or of methacrylic acid with 1 to 18, preferably 1 to 8 carbon atoms in the alcohol residue, such as, for example, methyl acrylate, ethyl acrylate, isopropyl acrylate, n-propyl acrylate, n-butyl acrylate, 2-ethylhexyl acrylate, n-stearyl acrylate, the methacrylates corresponding to these acrylates, styrene, alkyl-substituted styrenes, acrylonitrile, methacrylonitrile, vinyl acetate or vinyl stearate, and any desired mixtures of such monomers.

The hydroxyl-bearing monomers are used in the copolymerization of the hydroxyl-bearing (meth)acrylates in a mixture with other polymerizable monomers, preferably free-radically polymerizable monomers, preferably those composed to an extent of more than 50% by weight of C₁-C20, preferably C₁ to C₄ alkyl (meth)acrylate, (meth)acrylic acid, vinylaromatics having up to 20 C atoms, vinyl esters of carboxylic acids comprising up to 20 C atoms, vinyl halides, nonaromatic hydrocarbons having 4 to 8 C atoms and 1 or 2 double bonds, unsaturated nitriles, and mixtures thereof. Particular preference is given to the polymers composed—besides the hydroxyl-bearing monomers—to an extent of more than 60% by weight of C₁-C₁₀ alkyl (meth)acrylates, styrene and its derivatives, or mixtures thereof.

The polymers can be prepared by polymerization in accordance with customary processes. The preparation of the polymers takes place preferably in an emulsion polymerization or in organic solution. Continuous or discontinuous polymerization processes are possible. The discontinuous processes include the batch process and the feed process, the latter being preferred. With the feed process, the solvent is introduced as an initial charge alone or together with part of the monomer mixture, and this initial charge is heated to the polymerization temperature, the polymerization is initiated free-radically in the case of an initial charge of monomer, and the remaining monomer mixture is metered in together with an initiator mixture over the course of 1 to 10 hours, preferably 3 to 6 hours. Optionally, thereafter, activation is repeated in order to carry through the polymerization to a conversion of at least 99%.

Further binders are, for example, polyesterpolyols, as are obtainable by condensing polycarboxylic acids, especially dicarboxylic acids, with polyols, especially diols. In order to ensure a polyester polyol functionality that is appropriate for the polymerization, use is also made in part of triols, tetrols, etc, and also triacids etc.

Polyester polyols are known for example from Ullmanns Encyklopädie der technischen Chemie, 4th edition, volume 19, pp. 62 to 65. It is preferred to use polyester polyols which are obtained by reacting dihydric alcohols with dibasic carboxylic acids. In lieu of the free polycarboxylic acids it is also possible to use the corresponding polycarboxylic anhydrides or corresponding polycarboxylic esters of lower alcohols or mixtures thereof to prepare the polyester polyols. The polycarboxylic acids may be aliphatic, cycloaliphatic, aromatic or heterocyclic and may optionally be substituted, by halogen atoms for example, and/or unsaturated. Examples thereof that may be mentioned include the following:

Oxalic acid, maleic acid, fumaric acid, succinic acid, glutaric acid, adipic acid, sebacic acid, dodecanedioic acid, o-phthalic acid, isophthalic acid, terephthalic acid, trimellitic acid, azelaic acid, 1,4-cyclohexanedicarboxylic acid or tetrahydrophthalic acid, suberic acid, azelaic acid, phthalic anhydride, tetrahydrophthalic anhydride, hexahydrophthalic anhydride, tetrachlorophthalic anhydride, endomethylenetetrahydrophthalic anhydride, glutaric anhydride, maleic anhydride, dimeric fatty acids, their isomers and hydrogenation products, and also esterifiable derivatives, such as anhydrides or dialkyl esters, C₁-C₄ alkyl esters for example, preferably methyl, ethyl or n-butyl esters, of the stated acids are employed. Preference is given to dicarboxylic acids of the general formula HOOC—(CH₂)_{y}—COOH, where y is a number from 1 to 20, preferably an even number from 2 to 20, and more preferably succinic acid, adipic acid, sebacic acid, and dodecanedicarboxylic acid.

Suitable polyhydric alcohols for preparing the polyesterols include 1,2-propanediol, ethylene glycol, 2,2-dimethyl-1,2-ethanediol, 1,3-propanediol, 1,2-butanediol, 1,3-butanediol, 1,4-butanediol, 3-methylpentane-1,5-diol, 2-ethylhexane-1,3-diol, 2,4-diethyloctane-1,3-diol, 1,6-hexanediol, polyTHF having a molar mass of between 162 and 4500, preferably 250 to 2000, poly-1,3-propanediol having a molar mass between 134 and 1178, poly-1,2-propanediol having a molar mass between 134 and 898, polyethylene glycol having a molar mass between 106 and 458, neopentyl glycol, neopentyl glycol hydroxypivalate, 2-ethyl-1,3-propanediol, 2-methyl-1,3-propanediol, 2,2-bis(4-hydroxycyclohexyl)propane, 1,1-, 1,2-, 1,3- and 1,4-cyclohexanedimethanol, 1,2-, 1,3- or 1,4-cyclohexanediol, trimethylolbutane, trimethylolpropane, trimethylolethane, neopentyl glycol, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol or isomalt, which optionally may have been alkoxylated as described above.

Preferred alcohols are those of the general formula HO—(CH₂)ₙ—OH, where x is a number from 1 to 20, preferably an even number from 2 to 20. Preferred are ethylene glycol, butane-1,4-diol, hexane-1,6-diol, octane-1,8-diol and dodecane-1,12-diol. Additionally preferred is neopentyl glycol.

Also suitable, furthermore, are polycarbonate diols of the kind obtainable, for example, by reacting phosgene with an excess of the low molecular mass alcohols specified as synthesis components for the polyester polyols.

Also suitable are lactone-based polyester diols, which are homopolymers or copolymers of lactones, preferably hydroxy-terminated adducts of lactones with suitable difunctional starter molecules. Suitable lactones are preferably those which derive from compounds of the general formula HO—(CH₂)ₙ—COOH, where z is a number from 1 to 20 and where one H atom of a methylene unit may also have been substituted by a C₁ to C₄ alkyl radical. Examples are ε-caprolactone, β-propiolactone, gamma-butyrolactone and/or methyl-ε-caprolactone, 4-hydroxybenzoic acid, 6-hydroxy-2-naphthoic acid or pivalolactone, and mixtures thereof. Examples of suitable starter components include the low molecular mass dihydric alcohols specified above as a synthesis component for the polyester polyols. The corresponding polymers of ε-caprolactone are particularly preferred. Lower polyester diols or polyether diols as well can be used as starters for preparing the lactone polymers. In lieu of the polymers of lactones it is also possible to use the corresponding, chemically equivalent polycondensates of the hydroxycarboxylic acids corresponding to the lactones.

In polyurethane coating materials, molar masses Mₙ of the polyesters of 800-4000 g/mol are customary, with the polyesters used here not being confined to this figure.

Additionally suitable as binders are polyetherols, which are prepared by addition of ethylene oxide, propylene oxide and/or butylene oxide, preferably ethylene oxide and/or propylene oxide, and more preferably ethylene oxide, with H-active components. Polycondensates of butanediol are also suitable. In polyurethane coating materials, molar masses of the polyethers of 500-2000 g/mol are customary, with the polyethers used here not being confined to this figure.

The polymers may be replaced at least in part by what are called reactive diluents. These may be blocked secondary or primary amines (aldimines and ketimines), or compounds having sterically hindered and/or electron-deficient secondary amino groups, examples being aspartic esters as per EP 403921 or WO 2007/39133.

For the curing of the film, polyisocyanate composition and binder are mixed with one another in a molar ratio of isocyanate groups to isocyanate-reactive groups of 0.2:1 to 5:1, preferably 0.8:1 to 1.2:1, and especially 0.9:1 to 1.1:1, and any further, typical coating constituents may optionally be incorporated by mixing, and the resulting material is applied to the substrate and cured at ambient temperature to 150° C.

In one preferred variant the coating material mixture is cured at ambient temperature to 80° C., more preferably to 60° C. (e.g., for refinish applications or large articles which are difficult to place into an oven).

In another preferred application, the coating material mixture is cured at 110-150° C., preferably at 120-140° C. (e.g., for OEM applications).

“Curing” in the context of the present invention refers to the production of a tack-free coating on a substrate, by the heating of the coating composition, applied to the substrate, at the temperature indicated above at least until at least the desired tack-free state has come about.

A coating composition in the context of the present specification means a mixture at least of the components provided for the coating of at least one substrate for the purpose of forming a film and, after curing, a tack-free coating.

The substrates are coated by typical methods known to the skilled person, with at least one coating composition being applied in the desired thickness to the substrate to be coated, and the optionally present volatile constituents of the coating composition being removed, optionally with heating. This operation may if desired be repeated one or more times. Application to the substrate may take place in a known way, as for example by spraying, troweling, knifecoating, brushing, rolling, rollercoating, flowcoating, laminating, injection backmolding or coextruding.

The thickness of a film of this kind for curing may be from 0.1 μm up to several mm, preferably from 1 to 2000 μm, more preferably 5 to 200 μm, very preferably from 5 to 60 μm (based on the coating material in the state in which the solvent has been removed from the coating material).

Additionally provided by the present invention are substrates coated with a multicoat paint system of the invention.

Polyurethane coating materials of this kind are especially suitable for applications requiring particularly high application reliability, exterior weathering resistance, optical qualities, solvent resistance, chemical resistance, and water resistance.

The two-component coating compositions and coating formulations obtained are suitable for coating substrates such as wood, wood veneer, paper, cardboard, paperboard, textile, film, leather, nonwoven, plastics surfaces, glass, ceramic, mineral building materials, such as molded cement blocks and fiber-cement slabs, or metals, which in each case may optionally have been precoated or pretreated.

Coating compositions of this kind are suitable as or in interior or exterior coatings, i.e., in those applications where there is exposure to daylight, preferably of parts of buildings, coatings on (large) vehicles and aircraft, and industrial applications, utility vehicles in agriculture and construction, decorative coatings, bridges, buildings, power masts, tanks, containers, pipelines, power stations, chemical plants, ships, cranes, posts, sheet piling, valves, pipes, fittings, flanges, couplings, halls, roofs, and structural steel, furniture, windows, doors, woodblock flooring, can coating and coil coating, for floor coverings, such as in parking levels or in hospitals and in particular in automotive finishes, as OEM and refinish application.

Coating compositions of this kind are used preferably at temperatures between ambient temperature to 80° C., preferably to 60° C., more preferably to 40° C. The articles in question are preferably those which cannot be cured at high temperatures, such as large machines, aircraft, large-capacity vehicles, and refinish applications.

In particular the coating compositions of the invention are used as clearcoat, basecoat, and topcoat material(s), primers, and surfacers.

It is an advantage of the polyisocyanate compositions of the invention that they maintain the color stability of polyisocyanate mixtures over a long time period in the presence of urethanization catalysts.

Polyisocyanate compositions of this kind can be employed as curing agents in coating materials, adhesives, and sealants.

By virtue of their low color number and high color stability they are of interest more particularly for coating compositions for clearcoat materials. Refinish applications are more particularly preferred.

### EXAMPLES

### Substances Used

### Polyisocyanate A: Isocyanurate Based on Hexamethylene Diisocyanate

Polyisocyanate A1, polyisocyanurate: hexamethylene diisocyanate HDI was reacted in the presence of 32 ppm of benzyltrimethylammonium hydroxyisobutyrate as catalyst, based on hexamethylene diisocyanate, 5% strength in ethyl hexanol, in a multi-stage reactor cascade with an average transit time per reactor of 20 minutes at 120° C. The reaction was stopped chemically using 12 ppm of di(2-ethylhexyl) phosphate, based on hexamethylene diisocyanate, as a 10% strength solution in methylglycol. Hexamethylene diisocyanate was distilled off under reduced pressure. 300 ppm of methoxyacetic acid and 100 ppm of BHT D1 were added. NCO content of the product: 22.2%, color number 21 Hz; viscosity: 2620 mPa*s.

Polyisocyanate A2, polyisocyanurate: experiment with hexamethylene diisocyanate, 37 ppm of benzyltrimethylammonium hydroxyisobutyrate as catalyst, based on hexamethylene diisocyanate, in solution in ethylhexanol, multistage reactor cascade with an average transit time per reactor of 20 minutes at 120° C., and thermal stopping. Removal of HDI by distillation under reduced pressure. NCO content of the product: 22.4%; color number: 37 Hz; viscosity: 2339 mPa*s. Addition of 100 ppm of Irganox 1135.

Polyisocyanate A3, polyisocyanurate: experiment with hexamethylene diisocyanate, 39 ppm of benzyltrimethylammonium hydroxyisobutyrate as catalyst, based on hexamethylene diisocyanate, in ethylhexanol. Reactor cascade with average transit time per reactor of 20 minutes at 120° C., stopped chemically with 15 ppm of di(2-ethylhexyl) phosphate, based on hexamethylene diisocyanate, 10% strength in ethylhexanol. Removal of HDI by distillation under reduced pressure. Stabilized with 300 ppm of methoxyacetic acid, 100 ppm of BHT. NCO content of the product: 21.9%; color number: 35 Hz; viscosity: 3300 mPa*s.

Polyisocyanate A4, polyisocyanurate: as polyisocyanate A1, but without BHT D1, having an NCO content of 20.8%; color number: 21 Hz; viscosity: 2400 mPa*s.

Polyisocyanate A5, polyisocyanurate: hexamethylene diisocyanate was reacted in the presence of 49 ppm of benzyltrimethylammonium hydroxyisobutyrate as catalyst, based on hexamethylene diisocyanate, in ethylhexanol, in a reactor cascade with an average dwell time per reactor of 10 minutes at 120° C., stopped chemically with 31 ppm of di(2-ethylhexyl) phosphate, based on hexamethylene diisocyanate, 10% strength in methylglycol. Removal of HDI by distillation under reduced pressure. Addition of 300 ppm of methoxyacetic acid and 100 ppm of BHT D1. NCO content of the product: 22.2%; color number: 19 Hz; viscosity: 2730 mPa*s.

Polyisocyanate A6: polyisocyanurate prepared with DABCO TMR (trimethylhydroxypropyl-ammonium ethylhexanoate, Air Products) as catalyst and thermal stopping of the isocyanuratization reaction at about 140° C. NCO content of the product: 22.1%; color number 15 Hz; viscosity: 3960 mPa*s.

### Catalysts B

Catalyst B1: dibutyltin dilaurate (DBTL, DBTDL)

Brønsted Acids C

Brønsted acid C1: di(2-ethylhexyl) phosphate (DEHP, Lanxess)

Brønsted acid C2: dodecylphenolsulfonic acid (Nacure® 5076, King Industries)

Brønsted acid C3: dioctylphosphinic acid (Irgafos® OPH, BASF SE).

### Sterically Hindered Phenols D

Phenol D1: 2,6-di-tert-butyl-4-methylphenol (BHT)

Phenol D2: isooctyl 3-(3,5-di-tert-butyl-4-hydroxyphenyl)propionate (Irganox® 1135 from BASF SE)

### Solvents E

Solvent E1:solvent naphtha (boiling range about 170-180° C.)

The polyisocyanates A were stored in about 50% by weight with the concentrations—indicated in the experiments—of Lewis acid catalysts (B), Brønsted acid (C), phenols (D), approximately 50% by weight in solvent (E) in tightly closed screw-top vessels under nitrogen in order to exclude air. Traces of air are not excluded.

The % by weight figures are based on 100% total weight relative to polyisocyanate A and solvent E. The concentrations of the compounds (B), (C), (D) in ppm are based, in the respectively undiluted state of the compounds (B) to (D), on the total amount of polyisocyanate (A).

Storage takes place at 50° C. in a forced-air oven. The color numbers are measured directly (immediately before the beginning of storage), and after storage for different time periods.

Color number measurement takes place in APHA in accordance with DIN EN 1557 on a Lico 150 from Lange in a 5 cm cell with a volume of 5 ml. The error tolerances are as follows: for the target value 20 Hz (+/−5, actual value 18 Hz); target value 102 Hz (+/−10, actual value 99 Hz); target value 202 Hz (+/−20, actual value 197 Hz).

Each measurement was compared directly against a reference example (Ref.) which was stabilizer-free.

TABLE 1
Storage of polyisocyanate A1 (50%), Solvesso 100
E, 1000 ppm of catalyst B1 (DBTL), and further
components as per the table below, at 50° C.

| | | Acid | Phenol | C3 | 0 | 7 | 28 | 70 |
|---|---|---|---|---|---|---|---|---|
| No. | PI | ppm | ppm | ppm | days | | | |
| Comp. 1 | A1 | | 100 D1 | | 10 | 16 | 59 | 137 |
| Ex. 1 | A1 | 40 C1 | 100 D1 | | 10 | 16 | 22 | 113 |
| Ex. 2 | A1 | 10 C2 | 100 D1 | | 8 | 16 | 25 | 54 |
| Ex. 3 | A1 | 10 C2 | 100 D1 | 300 | 8 | 11 | 18 | 19 |
| Comp. 2 | A4 | | | | 11 | 51 | 80 | 194 |
| Comp. 3 | A1 | | 100 D1 | | 10 | 16 | 59 | 137 |
| Comp. 4 | A4 | 40 C1 | | | 9 | 64 | 109 | 187 |
| Ex. 4 | A4 | 40 C1 | 100 D1 | | 9 | 15 | 22 | 68 |
| Comp. 5 | A1 | | 100 D2 | | 10 | 19 | 63 | 141 |
| Ex. 5 | A1 | 40 C1 | 100 D2 | | 10 | 18 | 27 | 99 |
| Comp. 6 | A2 | | 100 D2 | | 17 | 52 | 61 | 113 |
| Comp. 7 | A2 | | 100 D2 | | 16 | 39 | 52 | 80 |
| | | | 300 D1 | | | | | |
| Ex. 6 | A2 | 50 C1 | 100 D2 | | 16 | 11 | 18 | 62 |
| Ex. 7 | A2 | 50 C1 | 100 D2 | | 16 | 13 | 19 | 58 |
| | | | 300 D1 | | | | | |
| Comp. 8 | A3 | | 100 D1 | 300 | 20 | 19 | 57 | 94 |
| Ex. 8 | A3 | 20 C1 | 100 D1 | 300 | 19 | 18 | 16 | 74 |
| Ex. 9 | A3 | 40 C1 | 100 D1 | 300 | 19 | 17 | 17 | 59 |
| Comp. 9 | A5 | | 100 D1 | | 11 | 21 | 76 | 175 |
| Ex. 10 | A5 | 40 C1 | 100 D1 | | 11 | 21 | 26 | 127 |
| Comp. 10 | A6 | | | | 11 | 91 | 70 | 117 |
| Comp. 11 | A6 | 40 C1 | | | 10 | 134 | 176 | 180 |
| Comp. 12 | A6 | | 100 D1 | | 10 | 36 | 49 | 81 |
| Ex. 11 | A6 | 40 C1 | 100 D1 | | 10 | 24 | 48 | 65 |

1. A polyisocyanate composition comprising
(A) at least one polyisocyanate obtainable by reacting at least one monomeric isocyanate,
(B) at least one Lewis-acidic organometallic compound able to accelerate the reaction of isocyanate groups with isocyanate-reactive groups,
(C) at least one Brønsted acid having a pKa of less than 4,
(D) at least one sterically hindered phenol,
(E) at least one solvent,
(F) optionally other, typical coatings additives.

2. The polyisocyanate composition according to claim 1, wherein the monomeric isocyanate is a diisocyanate selected from the group consisting of 1,6-hexamethylene diisocyanate, isophorone diisocyanate, 1,3-bis(isocyanatomethyl)cyclohexane, 4,4′-di(isocyanatocyclohexyl)methane, and 2,4′-di(isocyanatocyclohexyl)methane.

3. The polyisocyanate composition according to claim 1 or 2, wherein the polyisocyanate (A) contains isocyanurate, biuret, urethane and/or allophanate groups and/or iminooxadiazinedione groups.

4. The polyisocyanate composition according to any of the preceding claims, wherein the polyisocyanate (A) comprises isocyanurate, urethane and/or allophanate groups prepared using an ammonium carboxylate or ammonium α-hydroxycarboxylate catalyst.

5. The polyisocyanate composition according to any of the preceding claims, wherein the polyisocyanate comprises a polyisocyanate comprising isocyanurate groups, having a viscosity of 600-4000 mPa*s, and/or a low-viscosity urethane and/or allophanate having a viscosity of 150-1600 mPa*s.

6. The polyisocyanate composition according to claim 1, wherein the Lewis-acidic organometallic compound (B) comprises a metal selected from the group consisting of tin, zinc, titanium, zirconium and bismuth or mixtures of such compounds.

7. The polyisocyanate composition according to claim 1, wherein compound (C) comprises acids selected from the group consisting of C1) dialkyl phosphates, C2) arylsulfonic acids, C3) phosphonates, and mixtures thereof.

8. The polyisocyanate composition according to claim 1, wherein compound (D) contains exactly one phenolic hydroxyl group per aromatic ring and carries an optionally substituted tert-butyl group in at least one, preferably both, ortho-position(s) relative to the phenolic hydroxyl group.

9. The polyisocyanate composition according to claim 8, wherein compound (D) is selected from the group consisting of 2,6-bis-tert-butyl-4-methylphenol (BHT), 3-[3,5-di-tert-butyl-4-hydroxyphenyl]propionic ester, pentaerythritol tetrakis(3-(3,5-di-tert-butyl-4-hydroxyphenyl)propionate), 3,3′,″, 5,5′,5″-hexa-tert-butyl-a,a′,a″-(mesitylene-2,4,6-triyl)tri-p-cresol, 1,3,5-tris(3,5-di-tert-butyl-4-hydroxybenzyl)-1,3,5-triazine-2,4,6(1H,3H,5H)-trione, isooctyl 3-(3,5-di-tert-butyl-4-hydroxyphenyl)propionate, and octadecyl 3-(3,5-di-tert-butyl-4-hydroxyphenyl)propionate.

10. The polyisocyanate composition according to any of the preceding claims, wherein the solvent (E) is selected from the group consisting of aromatic hydrocarbons, (cyclo)aliphatic hydrocarbons, ketones, esters, ethers, ether esters, and carbonates, more particularly from distillation cuts of aromatic hydrocarbons with predominantly C₉ and C₁₀ aromatics, and from dialkyl ketones.

11. A method of stabilizing a polyisocyanate composition comprising in addition to polyisocyanate (A) at least one compound (B) which is able to accelerate the reaction of isocyanate groups with isocyanate-reactive groups, which comprises admixing the polyisocyanate composition additionally with at least one Brømsted acid having a pKa of less than 4 (C), at least one phenol (D), at least one solvent (E), and optionally other, typical coatings additives (F).

12. A process for preparing a polyurethane coating material, which comprises reacting a polyisocyanate composition according to claim 11 with at least one binder which comprises isocyanate-reactive groups.

13. A process for preparing a polyurethane coating material, which comprises reacting a polyisocyanate composition according to either of claims 11 and 12 with at least one binder selected from the group consisting of polyacrylate polyols, polyester polyols, polyether polyols, polyurethane polyols, polyurea polyols, polyetherols, polycarbonates, polyester-polyacrylate polyols, polyester-polyurethane polyols, polyurethane-polyacrylate polyols, polyurethane-modified alkyd resins, fatty acid-modified polyester-polyurethane polyols, copolymers with allyl ethers, and copolymers and graft polymers of the stated groups of compounds.

14. The use of a polyisocyanate composition according to any of claims 1 to 11 as a curing agent in a coating composition, in primers, surfacers, pigmented topcoat, basecoat, and clearcoat materials in the segment of refinish, in automotive refinish, large-vehicle coating, and wood coating, and also as a curing agent in coating materials, adhesives, and sealants.

15. The use of a mixture of at least one Brønsted acid having a pKa of less than 4 (C) and at least one sterically hindered phenol (D) for reducing the color number of mixtures comprising at least one polyisocyanate (A), obtainable by reacting at least one monomeric isocyanate, and at least one Lewis-acidic organometallic compound (B) able to accelerate the reaction of isocyanate groups with isocyanate-reactive groups.
